(19) United States
(12) Patent Application Publication
(10) Pub. No.: US 2007/0294562 A1
(43) Pub. Date: Dec. 20, 2007

(54) SAN management method and a SAN management system

(76) Inventors: Kazuki Takamatsu, Kawasaki (JP); Takuya Okamoto, Machida (JP); Kenichi Endo, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/478,619

(22) Filed: Jul. 3, 2006

(30) Foreign Application Priority Data
Apr. 28, 2006 (JP) 2006-125960

(51) Int. Cl. G06F 11/00

(52) U.S. Cl. 714/4

(57) ABSTRACT

A SAN management method in which a host to which an application should be shifted can be decided so that the influence of data transfer load is eliminated as extremely as possible. To shift an application A operating on a host A to another host, a management server performs a data load conversion process S to predict data transfer load on the SAN in the case where the application will be shifted to a host B or C. The management server also performs a bottleneck analyzing process on each resource on the SAN. The management server further performs a destination host decision process on the basis of a result of the bottleneck analyzing process to decide a non-bottlenecked host as a destination host to which the application A should be shifted.

### INCORPORATION BY REFERENCE

The present application claims priority from Japanese application JP2006-125960 filed on Apr. 28, 2006, the content of which is hereby incorporated by reference into this application.

### BACKGROUND OF THE INVENTION

The present invention relates to a storage area network (hereinafter referred to as SAN) management method and a SAN management system. Particularly it relates to a SAN management method and a SAN management system in the case where an application is shifted by a cluster system.

In recent years, a system using a cluster system has been generally constructed for a transaction application requiring high availability. High availability means that a user can receive expected service. If, for example, service cannot be provided in a response time satisfactory to the user because of high load though the system is operating, the user may regard this state as a fault. Particularly when an application operated on a server is shifted to another server because of server failure (for the purpose of fail-over), performance guarantee of the application is especially important to a business critical application.

JP-A-2005-234917 (Paragraph 0013, FIG. 3) has described a technique in which performance information in each host is acquired by use of a test program at the ordinary time so that a destination host little in load change after fail-over can be selected.

JP-A-11-353292 (Paragraphs 0009 to 0020, FIG. 2) has described a technique in which priority inclusive of stopping of fail-over applications is changed in accordance with the operating states of resources on a fail-over destination so that performance after fail-over can be secured.

The capacity of necessary storages in an enterprise has increased acceleratedly and introduction of the SAN and increase in scale of the storages have advanced. To distribute load on data transfer paths and make the data transfer paths redundant, a multi-path management software is often used so that a plurality of data paths (logical paths which pass through host bus adapters (HBA) and channel adapters (CHA)) are set and used between a single host and each volume in a storage sub-system.

JP-A-2005-149281 (Paragraph 0099, FIG. 2) has described a technique in which fail-over is preventively performed before fault detection in all data paths to make it possible to shorten the fail-over switching time when a path fault occurs in the environment that a plurality of data paths are made redundant.

### SUMMARY OF THE INVENTION

All resources concerned with communication on the SAN are hardly exclusively used from hosts and applications because of economy and troublesomeness in configuration management. Particularly with the advance of increase in scale and complexity of the SAN environment, the case where SAN resources used between cluster systems are asymmetric and the case where resources are complexly shared have increased. For this reason, there is a possibility that performance of one application may be affected by data transfer load of another application on resources in the inside of the SAN. Consequently, it is difficult to predict resource-use load in the SAN when the application will be shifted to another host.

For the aforementioned reason, in the SAN, there is a possibility that performance of data transfer cannot be guaranteed because applications on other hosts use resources competing on the SAN even when applications on the destination host are stopped.

In addition, data transfer rate is not only affected by the SAN but also depends on CPU-use ratios on hosts. In such a situation, it is difficult to guarantee performance after fail-over.

The present invention is an invention for solving the aforementioned problem. An object of the invention is to provide a SAN management method and a SAN management system in which a host to which an application should be shifted can be decided so that the influence of data transfer load is eliminated as extremely as possible.

In the invention, information of load ratios of applications on each volume and information of data transfer load in accordance with each path are stored on a management server in order to predict data transfer load in the SAN when an application on one host will be shifted to another host. Current data transfer loads of the source application are summed up in accordance with each volume. The summed data transfer load is allocated equally to paths connected from any host to one and the same volume. The data transfer loads after allocation are summed up in accordance with each resource to thereby predict data transfer load each resource when the application will be shifted to the host.

Moreover, bottleneck analysis is performed on the basis of the prediction due to conversion of data transfer load. Therefore, an upper limit of performance in accordance with each resource on the SAN paths and priority of each application are stored on the management server. When the predicted data transfer load of each resource based on conversion of data transfer load is higher than the upper limit of performance, an application with low priority is selected arbitrarily and data transfer load corresponding to the application is deleted from path load information so that performance load is predicted when the application will be stopped. Moreover, prediction based on conversion of data transfer load is performed again, so that stopping of a low-priority application, prediction of data transfer load and bottleneck analysis are continued until a destination host free from such a bottleneck is found.

When it is difficult to predict performance or when the application switching time needs to be minimized, all stoppable applications are stopped on the basis of priority of the applications. On this occasion, the application is shifted to a host making the quickest response to the stop instruction so that the switching time of the source application can be minimized. After the application is shifted to the host on the basis of the method according to the invention, the stopped applications are started.

According to the invention, when an application currently operated on one host in a SAN environment needs to be shifted to another host, a host to which the application should be shifted can be decided so that the influence of data transfer load is eliminated as extremely as possible.

### BRIEF DESCRIPTION OF THE DRAWINGS

FIG. 1 is a block diagram showing the overall configuration of the present invention;

FIG. 2 is a conceptual view showing the gist of the present invention;

FIG. 3 is a block diagram showing the configuration of the management server;

FIG. 4 is an explanatory view showing an example of the path load table;

FIG. 5 is an explanatory view showing an example of the volume-use ratio table;

FIG. 6 is an explanatory view showing an example of the conversion rate table;

FIG. 7 is an explanatory view showing an example of the performance upper limit table;

FIG. 8 is an explanatory view showing an example of the application priority table;

FIG. 9 is a flow chart showing steps of the path information collection process;

FIG. 10 is a flow chart showing steps of the destination host decision process in Embodiment 1;

FIG. 11 is a flow chart showing steps of the data load conversion process;

FIG. 12 is an explanatory view showing data load information after conversion at shifting to the host B;

FIG. 13 is a flow chart showing steps of the bottleneck analyzing process;

FIG. 14 is an explanatory view showing a bottleneck analysis course at shifting to the host B;

FIG. 15 is an explanatory view showing data load information after conversion at shifting to the host C;

FIG. 16 is an explanatory view showing a bottleneck analysis course at shifting to the host C;

FIG. 17 is an explanatory view showing a bottleneck analysis course at the stopped application C and shifting to the host B;

FIG. 18 is an explanatory view showing a bottleneck analysis course at the stopped application C and shifting to the host C;

FIG. 19 is an explanatory view showing an example of the application shift information log; and

FIG. 20 is a flow chart showing steps of the destination host decision process in Embodiment 2.

### DESCRIPTION OF THE EMBODIMENTS

Embodiments of the invention will be described below with reference to the drawings.

### Embodiment 1

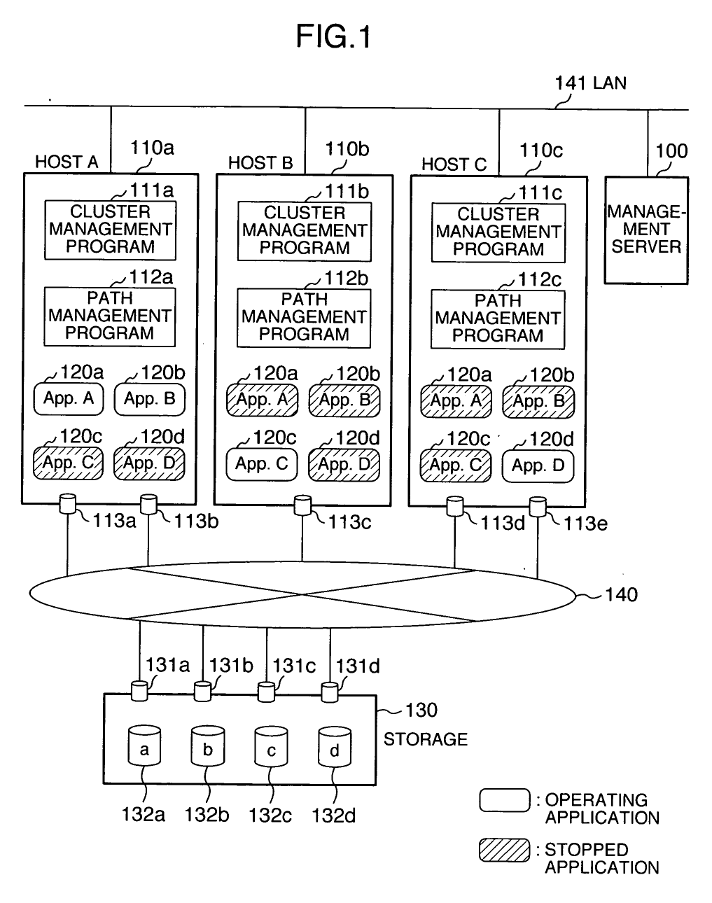

FIG. 1 is a block diagram showing the overall configuration of the invention. As shown in FIG. 1, a SAN management system includes a management server 100, hosts A to C 110a to 110c, and a storage 130 connected through a fibre channel (FC) network 140. The host A 110a is connected to the FC network 140 through HBA ports 113a and 113b. The host B 110b is connected to the FC network 140 through an HBA port 113c. The host C 110c is connected to the FC network 140 through HBA ports 113d and 113e.

The storage 130 is connected to the FC network 140 through CHA ports 131a to 131d. The management server 100 is connected to the hosts 110a to 110c by a local area network (LAN) 141. The storage 130 has logical volumes 132a to 132d which can be accessed through the FC network 140. Although FIG. 1 shows the case where three hosts 110a to 110c and one storage 130 are provided, four or more hosts and two or more storages may be provided.

The host A 110a includes application programs A to D (120a to 120d) (hereinafter referred to as “applications A to D (App. A to D)” simply) for using the storage 130, a path management program 112a, and a cluster management program 111a. The path management program 112a can acquire path configuration information, I/O request issued from the host A 110a, data transfer rate, etc. and transfer them to the management server 100. The cluster management program 111a monitors states of the applications A to D (120a to 120d) executed on the host and cooperates with a cluster management program executed on a different host when each monitored application is stopped. The cluster management program 111a starts and stops the applications A to D (120a to 120d) and shifts the applications to another host. In FIG. 1, on the host A 110a, the applications A and B (120a and 120b) are currently operated but the applications C and D (120c and 120d) are currently stopped.

The host B 110b includes applications A to D (120a to 120d) for using the storage 130, a path management program 112b, and a cluster management program 111b. The path management program 112b can acquire path configuration information, I/O request issued from the host B 110b, data transfer rate, etc. and transfer them to the management server 100. The cluster management program 111b monitors states of the applications A to D (120a to 120d) executed on the host and cooperates with a cluster management program executed on a different host when each monitored application is stopped. The cluster management program 111b starts and stops the applications A to D (120a to 120d) and shifts the applications to another host. In FIG. 1, on the host B 110b, the application C (120c) is currently operated but the applications A, B and D (120a, 120b and 120d) are currently stopped.

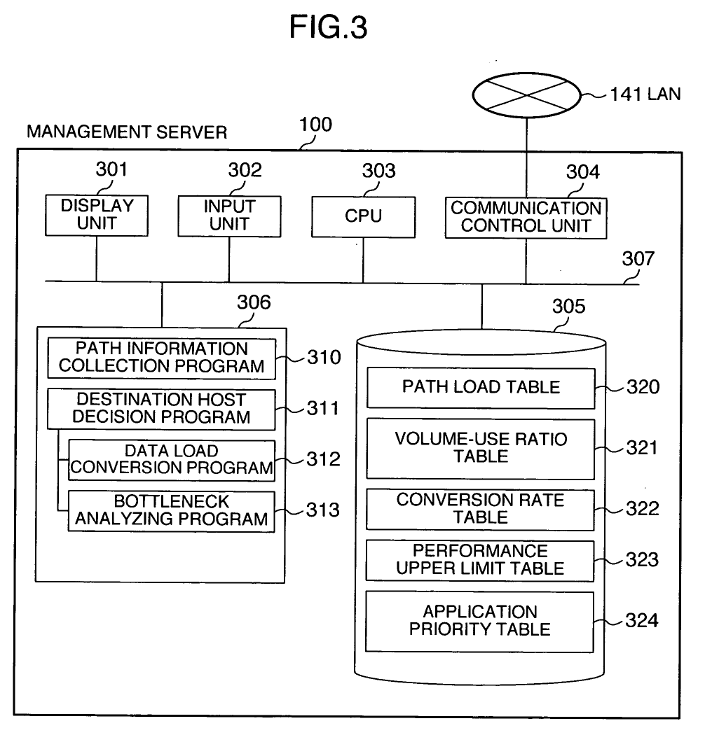

The host C 110c includes applications A to D (120a to 120d) for using the storage 130, a path management program 112c, and a cluster management program 111c. The path management program 112c can acquire path configuration information, I/O request issued from the host C 110c, data transfer rate, etc. and transfer them to the management server 100. The cluster management program 111c monitors states of the applications A to D (120a to 120d) executed on the host and cooperates with a cluster management program executed on a different host when each monitored application is stopped. The cluster management program 111c starts and stops the applications A to D (120a to 120d) and shifts the applications to another host. In FIG. 1, on the host C 110c, the application D (120d) is currently operated but the applications A, B and C (120a, 120b and 120c) are currently stopped. The configuration of the management server 100 will be described with reference to FIG. 3.

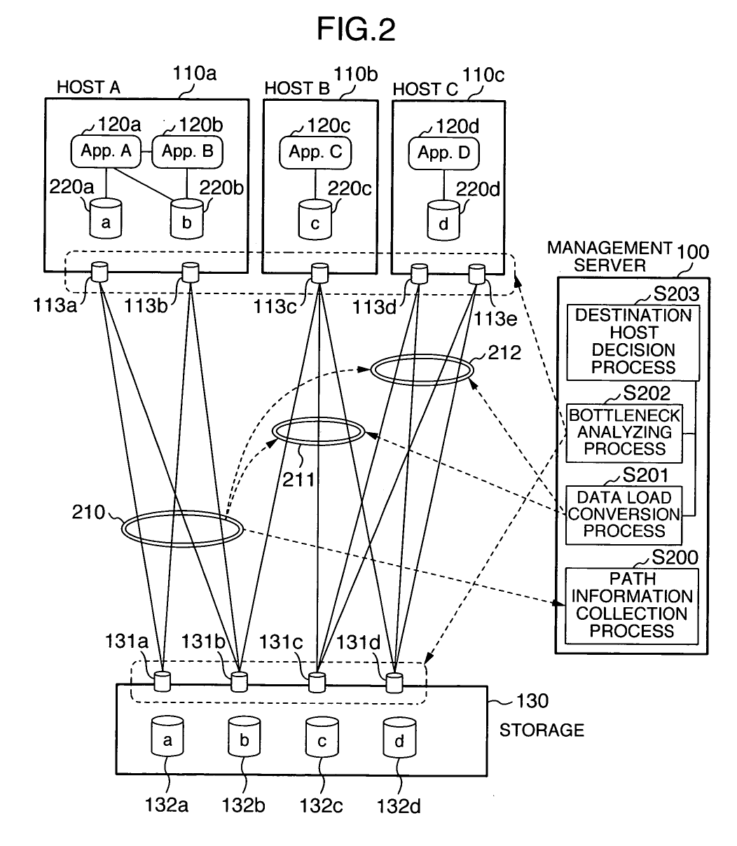

FIG. 2 is a conceptual view showing the gist of the invention. Though not shown in FIG. 2, the host A 110a has the cluster management program 111a and the path management program 112a. The host B 110b has the cluster management program 111b and the path management program 112b. The host C 110c has the cluster management program 111c and the path management program 112c.

To improve availability, the logical path from each of the hosts 110a to 110c to the storage 130 is made redundant by use of a plurality of ports. In this embodiment, HBA ports 113a and 113b and CHA ports 131a and 131b are used for connecting the host A 110a to the storage 130. The path management program on the host recognizes the redundant path as a logical path formed from a combination of the HBA ports and the CHA ports. In this embodiment, the host A 110a has four logical paths. In the conceptual view, such logical paths are used for description to clarify the point of the invention.

Similarly, in this embodiment, HBA ports 113d and 113e and CHA ports 131c and 131d are used for connecting the host C 110c to the storage 130. The host C 110c has four logical paths.

The respective configurations of the hosts are not always the same and may have different logical paths. In this embodiment, the host B 110b has three logical paths formed from combinations of one HBA port 113c and three CHA ports 131b, 131c and 131d.

The path management programs 112a to 112d (see FIG. 1) construct devices 220a to 220d corresponding to volumes 132a to 132d of the storage 130 on the hosts. Each device is an interface for each application to issue an I/O request, so that one device corresponds to one volume though the logical path is made redundant. In this embodiment, the application A (App.A) 120a accesses the volumes 132a and 132b by using the devices 220a and 220b. The application B (App.B) 120b accesses the volume 132b by using the device 220b. The application C (App.C) 120c accesses the volume 132c by using the device 220c. The application D (App.D) 120d accesses the volume 132d by using the device 220d.

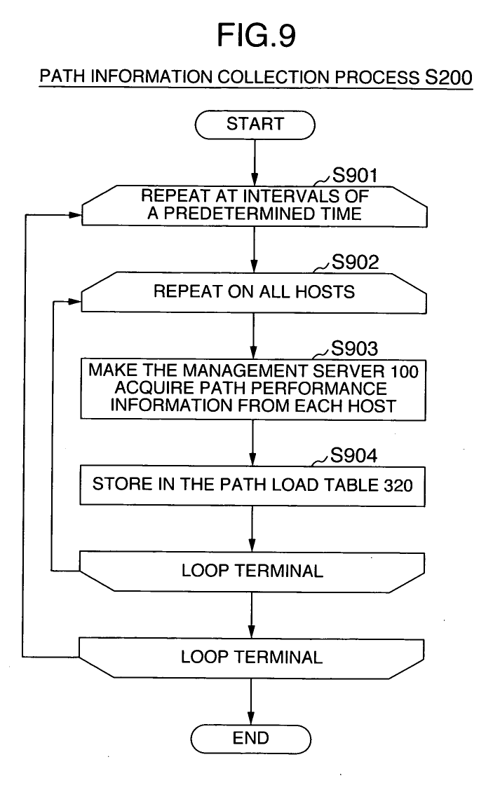

At an ordinary operation, the management server 100 performs a path information collection process S200. In this embodiment, assume that data transfer load per logical path is collected from the path management program (path management software) on each host. Incidentally, FIG. 9 shows detailed steps of the path information collection process S200.

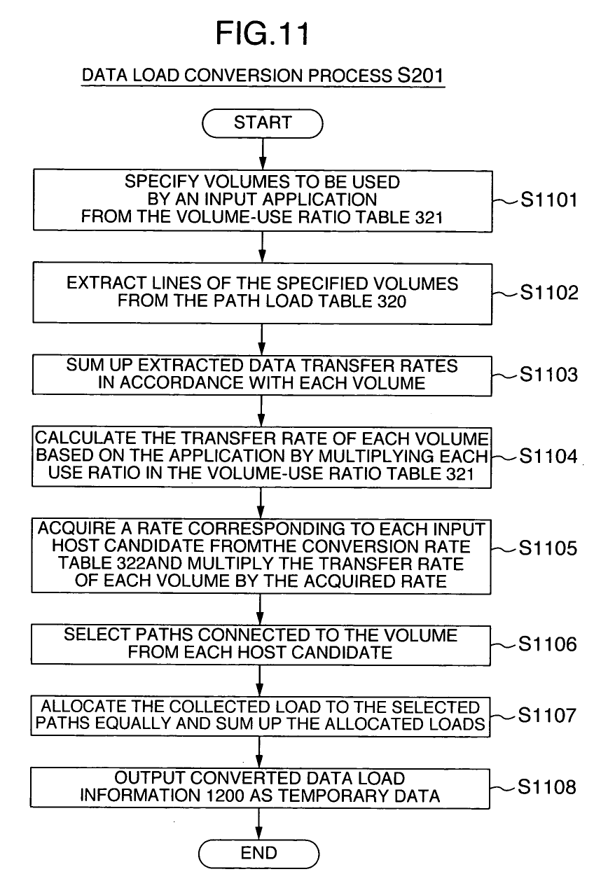

Assume now that the application A 120a is shifted to the host B 110b or the host C 110c. The turning point of shifting is, for example, in the case where a control portion (not shown) of the host A 110a detects any fault in the application A 120a on the basis of the cluster management program 111a. However, the turning point of shifting in the invention is not limited to the cluster management program (cluster management software) 111a. For example, shifting may be decided a little earlier when the control portion of the host A 110a detects a fault in part of the redundant path on the basis of the path management program (path management software) 112a. Alternatively, a user may designate a specific application for initial evaluation. When the application A 120a is selected, the management server 100 performs a data load conversion process S201 for converting data transfer load caused by the application A 120a into data transfer load on paths of each of the hosts B and C 110b and 110c which are destination host candidates. As a result, data transfer loads 211 and 212 to which source data transfer load 210 at shifting the application A 120a to the host B 110b or the host C 110c is converted are predicted. FIG. 11 shows detailed steps of the data load conversion process S201.

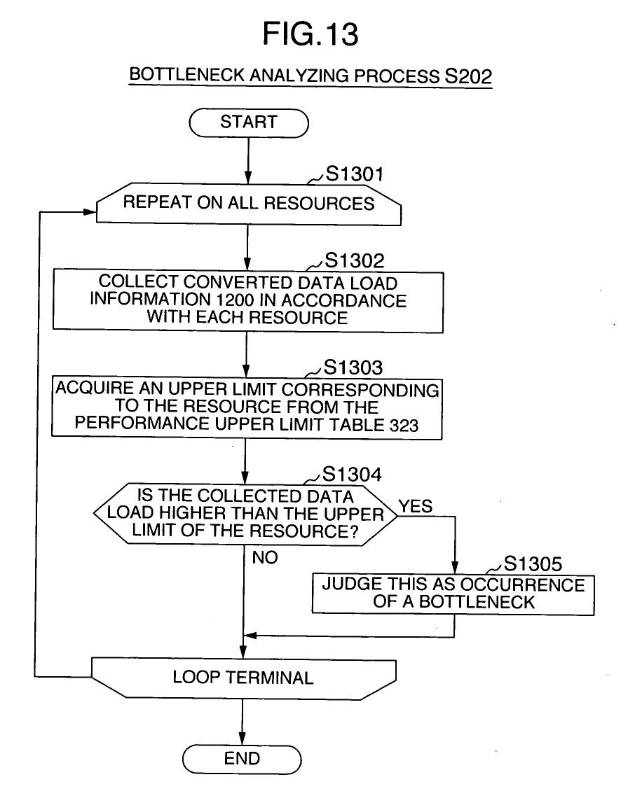

Then, the management server 100 performs a bottleneck analyzing process S202 in respective resources on the SAN on the basis of the prediction obtained by the data load conversion process S201. The respective resources on the SAN include the CHA ports 131a to 131d, and the HBA ports 113a to 113e. FIG. 13 shows detailed steps of the bottleneck analyzing process S202.

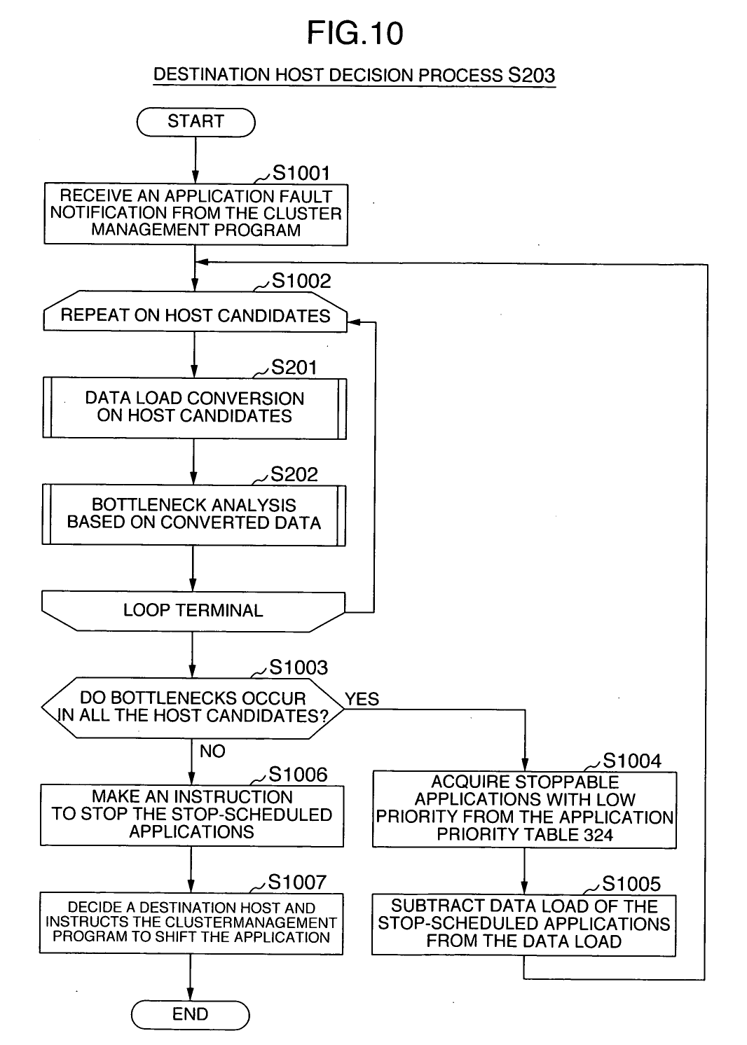

Finally, the management server 100 performs a destination host decision process S203 for deciding the destination host to which the application A 120a will be shifted, on the basis of the result obtained by the bottleneck analyzing process S202, so as to decide a destination host where no bottleneck occurs. The host A 110a is informed of the decided designation host, so that the application A 120a can be shifted. In the case of user's initial evaluation, the destination host and other evaluation contents are output as a result report. FIG. 10 shows detailed steps of the designation host decision process S203.

FIG. 3 is a block diagram showing the configuration of the management server. The management server 100 includes a display unit 301, an input unit 302, a central processing unit (CPU) 303, a communication control unit 304, an external storage unit 305, a memory 306, and a bus 307 for connecting these units. The display unit 301 is a display or the like for displaying states, results, etc. of processes executed by the management server 100. The input unit 302 is a computer instruction input unit such as a keyboard, a mouse, etc. for inputting an instruction such as a program start instruction. The central processing unit (CPU) 303 executes various kinds of programs stored in the memory 306. The communication control unit 304 exchanges various kinds of data or commands with another device through the LAN 141. The external storage unit 305 stores various kinds of data necessary for the management server 100 to execute processing. The memory 306 stores various kinds of programs and temporary data necessary for the management server 100 to execute processing.

A path load table 320, a volume-use ratio table 321, a conversion rate table 322, a performance upper limit table 323 and an application priority table 324 are stored in the external storage unit 305.

A path information collection program 310, a destination host decision program 311, a data load conversion program 312 and a bottleneck analyzing program 313 are stored in the memory 306.

The path information collection program 310 is a program for executing the path information collection process S200. The path information collection program 310 collects host performance information acquired through the communication control unit 304 and stores the information in the path load table 320.

The data load conversion program 312 performs the data load conversion process S201 by using the path load table 320, the volume-use ratio table 321 and the conversion rate table 322.

The bottleneck analyzing program 313 performs the bottleneck analyzing process S202 by using the conversion result and the performance upper limit table 323.

The destination host decision program 311 converts load by executing the data load conversion program 312 and executes the bottleneck analyzing program 313 with the conversion result as an input.

The destination host decision program 311 performs the destination host decision process S203 on the basis of the bottleneck analysis result and the application priority table 324.

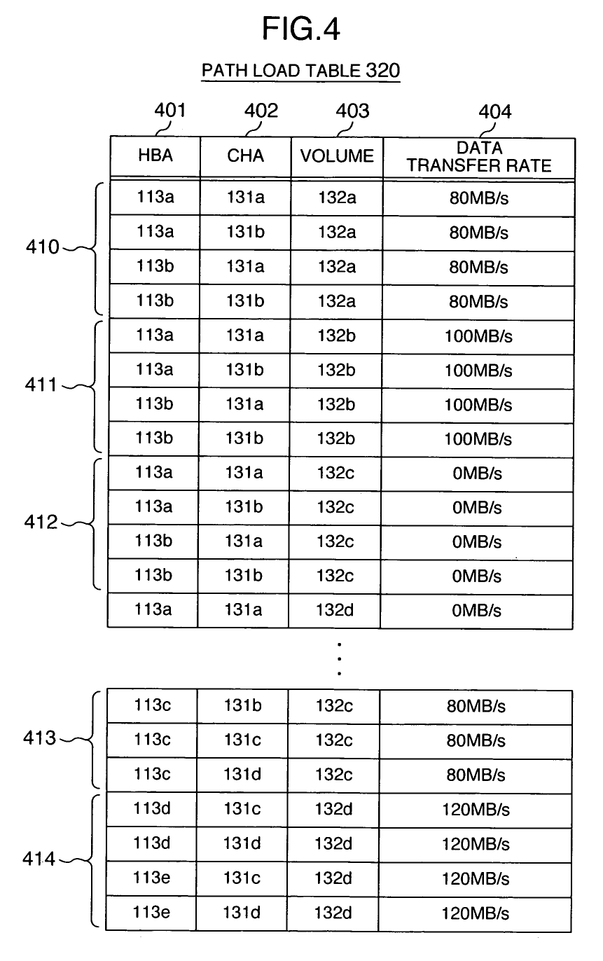

FIG. 4 is an explanatory view showing an example of the path load table. The path load table 320 shown in FIG. 4 has combinations of HBA 401, CHA 402 and volume 403 as path information and stores data transfer rates 404 in accordance with the logical paths. The HBA 401 is HBA port identification information expressed by a combination of the World Wide Name (WWN) or host name of the HBA port and the port number thereof. The CHA 402 is CHA port identification information expressed by a combination of the WWN or storage name of the CHA port and the port number thereof. The volume 403 is a volume identifier expressed by a combination of the storage name and the volume number. In this embodiment, these are expressed by numbers used in FIGS. 1 and 2.

As shown in FIG. 4, data transfer rate (per second) is used as the value of data transfer load. Alternatively, the number of I/O request issues or the like may be used as the value of data transfer load. The recorded data are average data of operating results at the ordinary operation. In this embodiment, short-term averages are calculated by the path management programs 112a to 112c of the hosts 110a to 110c. On the other hand, performance information in accordance with time series may be accumulated in the management server 100 so that long-term averages can be calculated and used. In the invention, the kind of data load information and the way of averaging load information are not limited.

As a specific example, the load on paths for the volume 132a is designated by 410. The number of the paths is four and the data transfer rate per path is 80 MB/s. This table further contains information of volumes which are not actually accessed. 411 designates paths from the host A 110a to the volume 132b. The number of the paths is four and the data transfer rate per path is 100 MB/s. 412 designates paths from the host A 110a to the volume 132c. In this case, the data transfer rate is 0 MB/s. 413 designates paths from the host B 110b to the volume 132c. The number of the paths is three and the data transfer rate per path is 80 MB/s. 414 designates paths from the host C 110c to the volume 132d. The number of the paths is four and the data transfer rate per path is 120 MB/s. Incidentally, data to not-accessed volumes may be input as virtual values. However, in the situation that an application with a fault in one host should be shifted to another host, the time required for fail-over must be shortened. For this reason, security setting for the SAN and device recognition on each host should be made at ordinary time so that the logical paths have been already set. When the logical paths have been already set, the path management software of each host can recognize each logical path as a path with a data transfer rate of 0 MB/s like the ordinary logical path and send information to the management server.

In this embodiment, data with a data transfer rate of 0 MB/s are partially not shown but 44 lines are actually present because 11 logical paths in total are present for four volumes 132a to 132d.

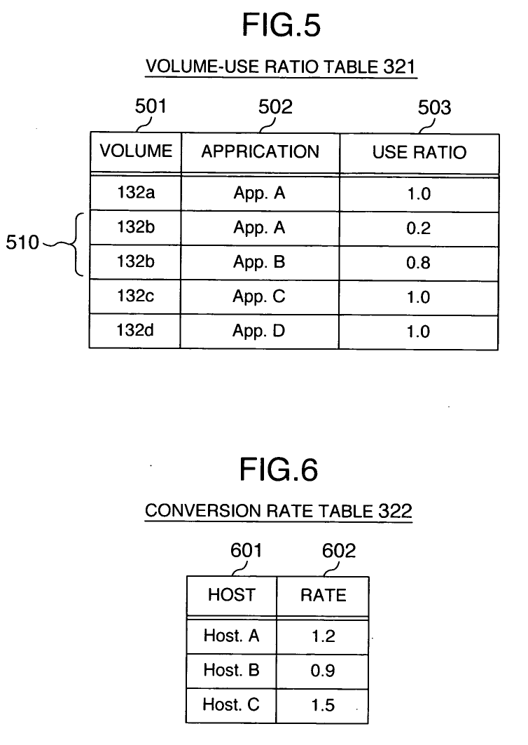

FIG. 5 is an explanatory view showing an example of the volume-use ratio table. The use ratio 503 of each application 502 with respect to data transfer load on the volume 501 is shown in the volume-use ratio table 321. In this embodiment, the application A (App.A) 120a in two lines (510) expressing data transfer load on the volume 132b uses the volume 132b at a ratio of 0.2 while the application B (App.B) 120b uses the volume 132b at a ratio of 0.8. At access through a file system, such a case occurs. On the other hand, the number of applications using the volume 132a, 132c or 132d is limited. In this case, each application uses the volume at a ratio of 1.0.

FIG. 6 is an explanatory view showing an example of the conversion rate table. The conversion rate 602 of data transfer load for the host 601 is set in the conversion rate table 322. The host A (Host.A) 110a, the host B (Host.B) 110b or the host C (Host.C) 110c is set as the host 601. Even when one and the same application is executed on each host, a greater deal of processing may be made on a high-performance host so that a larger number of I/O requests are issued from the high-performance host. The conversion rate 602 is provided for taking the aforementioned situation into a predicted value based on conversion. For example, the rate of the host A (Host.A) 110a is 1.2 while the rate of the host C (Host.C) 110c is 1.5. This shows that conversion of performance load into 1.5/1.2=1.25 times is made when the application on the host A 110a is executed on the host C 110c.

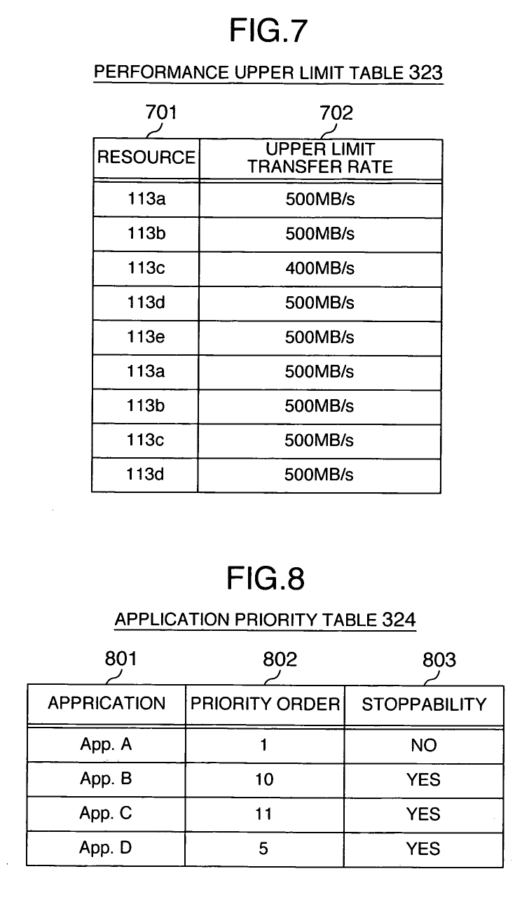

FIG. 7 is an explanatory view showing an example of the performance upper limit table. The upper limit of data transfer load (upper limit transfer rate) 702 in accordance with each resource 701 is stored in the performance upper limit table 323. In this embodiment, the HBA ports 113a to 113e and the CHA ports 131a to 131d are considered as resources. For example, the upper limit data transfer rate allowed by the HBA port 113c is 400 MB/s.

FIG. 8 is an explanatory view showing an example of the application priority table. Priority order 802 and stoppability 803 of each application 801 are stored in the application priority table 324. For example, the application A (App.A) 120a is a highest-priority and unstoppable application with priority order of 1. The application B (App.B) 120b is a stoppable application with priority order of 10.

Next, operation will be described mainly with reference to FIGS. 9, 10, 11 and 13 in connection with FIGS. 1 to 3.

FIG. 9 is a flow chart showing steps of the path information collection process. FIG. 9 shows a flow chart of the path information collection process S200 shown in FIG. 2. The path information collection process S200 collects data transfer loads in accordance with each logical path by path management programs (path management software) 112a to 112c on the hosts 110a to 110c on the basis of the path information collection program 310. The central processing unit (CPU) 303 repeats path information collection at intervals of a predetermined time (step S901). The repetition of path information collection at intervals of a predetermined time permits the latest path information to be obtained. The central processing unit 303 repeats path information collection for all the hosts 110a to 110c managed by the management server 100 (step S902). The central processing unit 303 acquires the data transfer rate per path by communicating with the path management programs 112a to 112c on the respective hosts on the basis of the path information collection program 310 (step S903) and stores the collected data transfer loads in the path load table 320 shown in FIG. 4 (step S904).

FIG. 10 is a flow chart showing steps of the destination host decision process in Embodiment 1. FIG. 10 shows a flow chart of the destination host decision process S203 shown in FIG. 2. In the destination host decision process S203, the data load conversion program 312 and the bottleneck analyzing program 313 are executed on the basis of the destination host decision program 311. The respective steps will be described in connection with a specific example.

The central processing unit (CPU) 303 receives a notification of an application with a fault from the cluster management programs 111a to 111c. An application to be shifted is selected on the basis of this notification. In this example, assume that a fault occurs in the application A (App.A) 120a and that a notification of occurrence of the fault is given by the cluster management program 111a (step S1001). The central processing unit 303 performs the following steps S201 and S202 on all destination host candidates. In this embodiment, the host candidates are the hosts B and C 110b and 110c (step S1002).

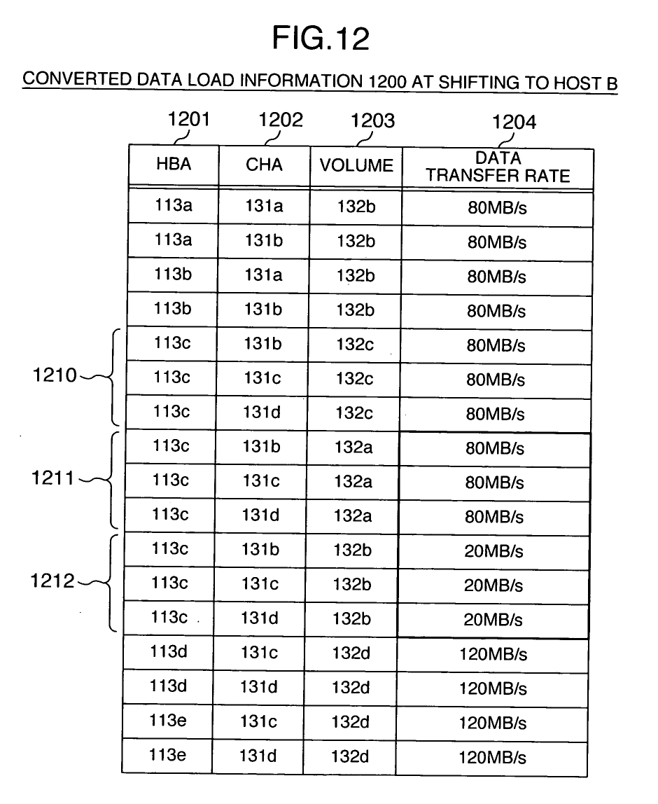

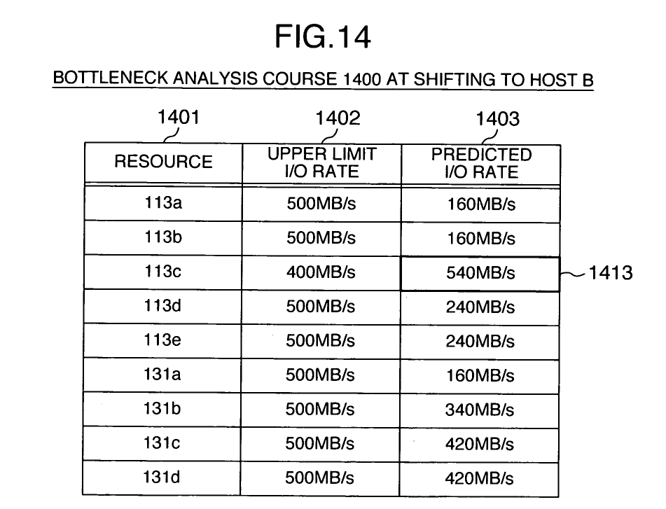

The central processing unit 303 performs data load conversion on the basis of the data load conversion program 312. The application with the fault and the destination host candidates are inputted, so that converted data transfer load on each of the destination host candidates is outputted (step S201). The central processing unit 303 performs bottleneck analysis on communication paths based on the bottleneck analysis program 313. The converted data transfer load outputted by the data load conversion program 312 is inputted and the presence/absence of a bottleneck is outputted (step S202). The converted data transfer load and the bottleneck analysis course in the case where the application will be shifted to the host B 110b in the steps S201 and S202 are shown in FIGS. 12 and 14 respectively.

FIG. 12 is an explanatory view showing data transfer load information after conversion at shifting to the host B. The data load information 1200 shown in FIG. 12 has combinations of the HBA 1201, the CHA 1202 and the volume 1203 as path information, like FIG. 4. A data transfer rate 1204 in accordance with each logical path is stored in the data load information 1200.

FIG. 14 is an explanatory view showing the bottleneck analysis course at shifting to the host B. An upper limit I/O rate 1402 and a predicted I/O rate 1403 in data transfer load in accordance with each resource 1401 are stored in the bottleneck analysis course 1400.

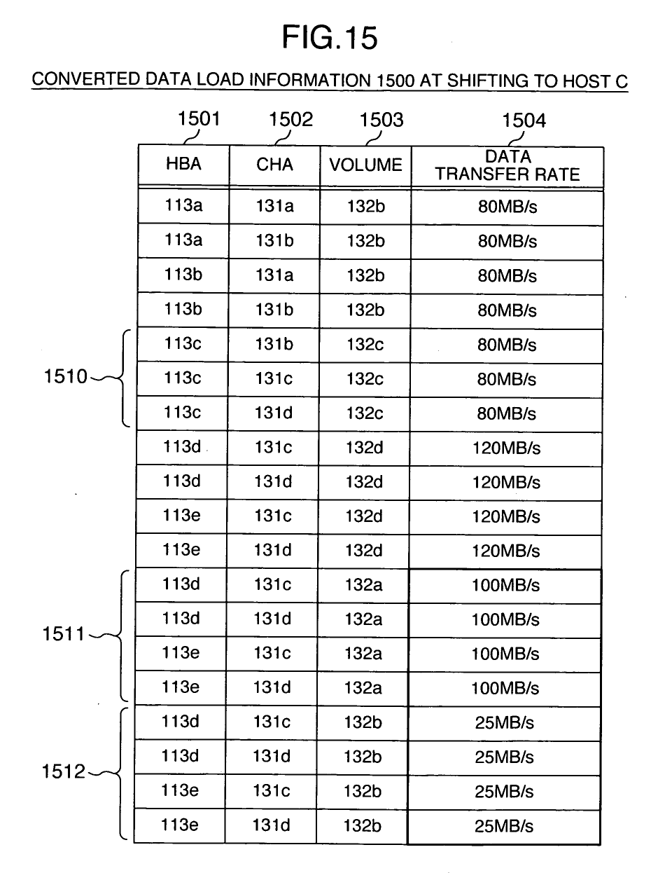

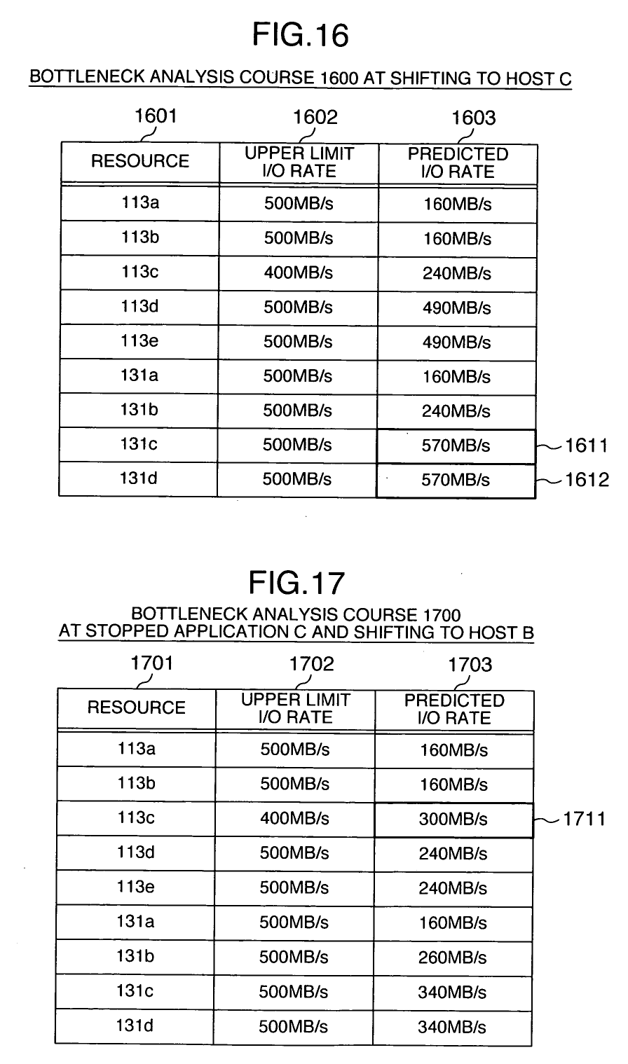

The converted data load and the bottleneck analysis course in the case where the application will be shifted to the host C 110c are shown in FIGS. 15 and 16 respectively.

FIG. 15 is an explanatory view showing data load information after conversion at shifting to the host C. The data load information 1500 shown in FIG. 15 has combinations of the HBA 1501, the CHA 1502 and the volume 1503 as path information, like FIG. 4. A data transfer rate 1504 in accordance with each logical path is stored in the data load information 1500.

FIG. 16 is an explanatory view showing the bottleneck analysis course at shifting to the host C. An upper limit I/O rate 1602 and a predicted I/O rate 1603 in data transfer load in accordance with each resource 1601 are stored in the bottleneck analysis course 1600.

The central processing unit 303 checks the presence/absence of bottlenecks (step S1003). If bottlenecks occur in all the destination host candidates, the current point of this routine goes to step S1004. In this specific example, when the application will be shifted to the host B 110b, a bottleneck occurs in the HBA port 113c as shown in FIG. 14. That is, the predicted I/O rate 1413 in the HBA port 113c is 540 MB/s which is higher than the upper limit I/O rate 400 MB/s. When the application will be shifted to the host C 110c, bottlenecks occur in the CHA ports 131c and 131d as shown in FIG. 16. That is, the predicted I/O rates 1611 and 1612 in the CHA ports 131c and 131d are 570 MB/s which is higher than the upper limit I/O rate 500 MB/s. When there is some host candidate free from any bottleneck in the step S1003, the current point of this routine goes to step S1006.

In step S1004, the central processing unit 303 acquires stoppable applications with lower priority than the application with the fault from the application priority table 324 (see FIG. 8). In this specific example, the stoppable applications with lower priority than the application A (App.A) are the application B (App.B), the application C (App.C) and the application D (App.D). The application C (App.C) with the lowest priority is selected from the stoppable applications. Incidentally, data load conversion may be performed on all applications satisfying a condition so that an application with the least deviation of data transfer load with respect to resources on the SAN after conversion is selected as a stop-scheduled application.

In step S1005, the central processing unit 303 subtracts data transfer load of the stop-scheduled application from the path load table 320 and predicts data load after the application will be stopped. Conversion of data load and bottleneck analysis are performed again on the basis of the data load (steps S1002, S201 and S202). In this specific example, data load of the application C (App.C) is subtracted.

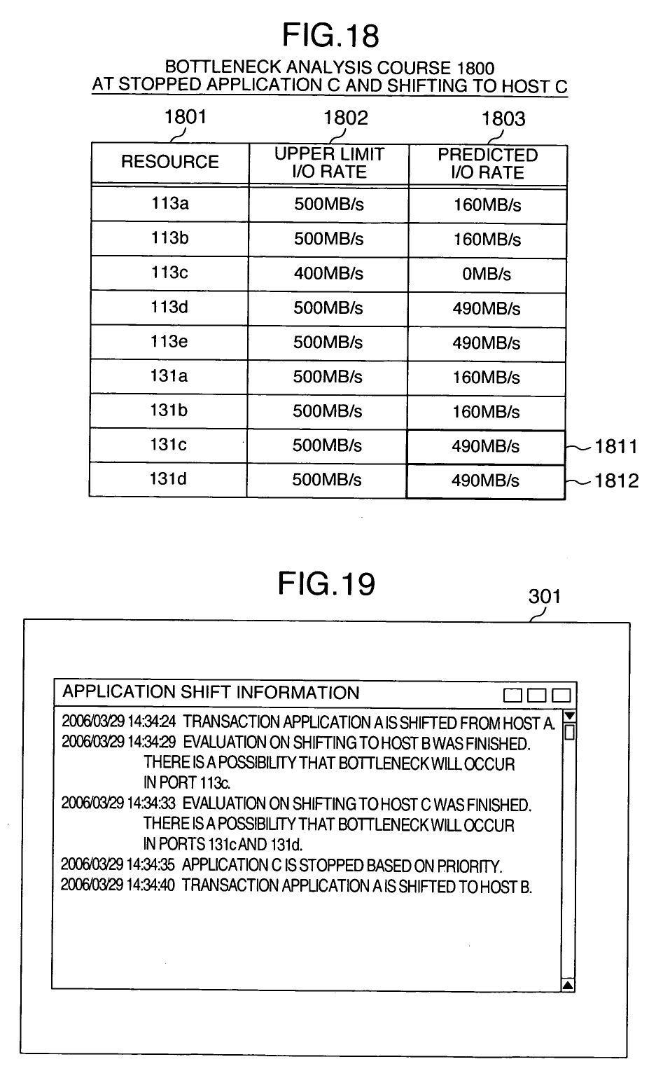

FIG. 17 shows the bottleneck analysis course at shifting to the host B in the case where the application C (App.C) is stopped. The bottleneck of the HBA port 113c is eliminated compared with FIG. 14 which shows the bottleneck analysis course at shifting to the host B before the application C (App.C) is stopped. That is, the predicted I/O rate 1711 in the HBA port 113c is 300 MB/s which is not higher than the upper limit I/O rate 400 MB/s. FIG. 18 shows the bottleneck analysis course at shifting to the host C in the case where the application C (App.C) is stopped. The bottlenecks of the CHA ports 131c and 131d are eliminated compared with FIG. 16 which shows the bottleneck analysis course at shifting to the host C before the application C (App.C) is stopped. That is, the predicted I/O rates 1811 and 1812 in the CHA ports 131c and 131d are 490 MB/s which is not higher than the upper limit I/O rate 500 MB/s. When no bottleneck occurs in all the host candidates in the step S1003, the current point of this routine goes to step S1006.

In the step S1006, the central processing unit 303 sends a stop notification to the host on which the stop-scheduled application is operating, when the stop-scheduled application is present. Thus, the stop-scheduled application is actually stopped. The stop-scheduled application is an application selected by the step S1004. A control portion of the host stops the application on the basis of the cluster management program. In this specific example, the host B is notified of the application C (App.C) as a stopped application. Incidentally, the reason why actual stopping is not performed in the step S1005 is that there is a possibility that no bottleneck will be eliminated even when all the stoppable applications are stopped.

In step S1007, the central processing unit 303 decides a destination host from host candidates free from any bottleneck and sends a notification to the control portion of the destination host. When there are hosts satisfying the condition, a host least in deviation of data loads on the respective resources is selected as a destination host. In this specific example, FIG. 17 shows the case of shifting to the host B after the application C (App.C) is stopped, whereas FIG. 18 shows the case of shifting to the host C after the application C (App.C) is stopped. In either case, no bottleneck occurs. On this occasion, the standard deviation of data loads on the respective resources in the case of shifting to the host B is 69 whereas the standard deviation of data loads on the respective resources in the case of shifting to the host C is 186. Accordingly, the host B small in deviation is decided as a destination host.

Incidentally, for example, a host large in average data transfer rate may be selected so that performance after shifting is maximized. In this specific example, the data transfer rate at shifting to the host B is 244 MB/s whereas the data transfer rate at shifting to the host C is 289 MB/s. Accordingly, the host C is selected as a destination host. In either case, the control portion of the host decided as a destination host is notified and the application is shifted.

FIG. 11 is a flow chart showing steps of the data load conversion process. FIG. 11 shows a flow chart of the data load conversion process S201 shown in FIG. 2. In the data load conversion process S201, data transfer load on the SAN with respect to the source application selected on the source host at shifting the application is converted into data transfer load of the source application on destination host candidates. The application to be shifted and the designation host candidates are called as an input from the destination host decision program 311. The case where the application A (App.A) 120a is shifted to the host B 110b will be described below as a specific example.

The central processing unit (CPU) 303 acquires information of volumes corresponding to the input application from the volume-use ratio table 321. In this specific example, the input application is the application A (App.A) and the corresponding volumes are the volumes 132a and 132b (step S1101). The central processing unit 303 extracts lines corresponding to the volumes specified in the step S1101 from the path load table 320 (see FIG. 4). In this specific example, lines 410 and 411 are extracted (step S1102). The central processing unit 303 sums up the extracted data transfer rates in accordance with each volume. In this specific example, the data transfer rate corresponding to the volume 132a is 320 MB/s whereas the data transfer rate corresponding to the volume 132b is 400 MB/s (step S1103).

The central processing unit 303 calculates the data transfer rate per volume of the input application by multiplying the value calculated in the step S1103 by the use ratio in the volume-use ratio table 321 (see FIG. 5). The data transfer rate corresponding to the volume 132a is multiplied by 1.0, resulting in 320 MB/s, whereas the data transfer rate corresponding to the volume 132b is multiplied by 0.2, resulting in 80 MB/s (step S1104). The central processing unit 303 acquires a rate corresponding to each host candidate from the conversion rate table 322 (see FIG. 6) and multiples the value calculated in the step S1104 by the rate. In this specific example, 0.9/1.2=0.75. Accordingly, the data transfer rate corresponding to the volume 132a is converted into 320×0.75=240, whereas the data transfer rate corresponding to the volume 132b is converted into 80×0.75=60 (step S1105). The central processing unit 303 selects paths from the host candidate to the volumes used by the application to be shifted. In this specific example, the paths are equivalent to 1211 and 1212 shown in FIG. 12. Incidentally, at this point of time, the data transfer rates in the paths 1211 and 1222 are zero (step S1106).

The central processing unit 303 equally allocates the value calculated in the step S1105 to the paths selected in the step S1106 and sums up the allocated values. In this specific example, the data transfer rate 240 MB/s calculated in the step S1106 is added to the paths 1211 corresponding to the volume 132a. Because the paths 1211 are three paths, the data transfer rate of each path with respect to the volume 132a is allocated as 80 MB/s. Similarly, 20 MB/s is allocated to each path 1212 with respect to the volume 132b (step S1107). The central processing unit 303 outputs converted data transfer load as an output. The converted data load information 1200 at shifting to the host B (see FIG. 12) is data load information after conversion. Incidentally, lines of the data transfer rate 0 MB/s are not shown (step S1108).

FIG. 13 is a flow chart showing steps of the bottleneck analyzing process. FIG. 13 shows a flow chart of the bottleneck analyzing process S202 shown in FIG. 2. In the bottleneck analyzing process S202, the bottleneck of communication paths based on the data transfer load after data load conversion is analyzed on the basis of the bottleneck analyzing program 313. The data transfer load after conversion is called as an input from the destination host decision program 311. In the specific example, the data load information 1200 after the conversion is shown as an input.

The central processing unit (CPU) 303 repeats the following steps on the respective resources on the SAN. In this embodiment, the respective resources are the HBA ports 113a to 113e and the CHA ports 131a to 131d (step S1301). The central processing unit 303 collects converted data transfer loads in accordance with each resource. In this specific example, the value collected for the HBA port 113a is 160 MB/s. A result of collection for all resources in the step S1301 is shown in the bottleneck analysis course 1400 at shifting to the host B shown in FIG. 14. The collected value corresponding to each resource 1401 is the predicted I/O rate 1403 (step S1302). The central processing unit 303 acquires an upper limit (upper limit I/O rate) corresponding to the resource from the performance upper limit table 323. In the specific example, the upper limit data transfer rate corresponding to the HBA port 113a is 500 MB/s. FIG. 14 also shows the upper limit (upper limit I/O rate) 1402 acquired from the performance upper limit table 323 to make understanding easy (step S1303). The central processing unit 303 checks whether the collected data transfer load is higher than the upper limit load of each resource. When the collected data transfer load is higher than the upper limit load, the current point of this routine goes to step S1305. In this specific example, the collected value (predicted I/O rate) 1413 in the HBA port 113c as a resource is higher than the upper limit 400 MB/s (step S1304). The central processing unit 303 calls the presence/absence of a bottleneck as an output and transmits it to the requesting program (step S1305). The case where the application A (App.A) is shifted to the host B has been described above.

On the other hand, the case where the application A (App.A) is shifted to the host C is as follows. First, conversion by the data load conversion program 312 is as follows. In step S1106, 1.5/1.2=1.25. Accordingly, the transfer rate corresponding to the volume 132a is 320×1.25=400 MB/s, whereas the transfer rate corresponding to the volume 132b is 80×1.25=100 MB/s. In step S1107, paths are equivalent to 1511 and 1512 shown in FIG. 15. Because the paths after conversion are four, in step S1108, the data transfer rate in each path with respect to the volume 132a is 100 MB/s. Similarly, the data transfer rate in each path 1512 with respect to the volume 132b is 25 MB/s. The converted data transfer load output in the step S1108 is shown in the data load information 1500 after conversion at shifting to the host C (see FIG. 15).

Then, as shown in FIG. 16, in the bottleneck analysis course 1600 at shifting to the host C, collection results 1611 and 1612 for the CHA ports 131c and 131d are both 570 MB/s. That is, bottlenecks occur.

FIG. 17 is an explanatory view showing the bottleneck analysis course at the stopped application C and shifting to the host B. An upper limit I/O rate 1702 and a predicted I/O rate 1703 in data transfer load in accordance with each resource 1701 are stored in the bottleneck analysis course 1700. In step S1004 (see FIG. 10), the central processing unit 303 (see FIG. 3) acquires stoppable applications with low priority from the application priority table 324. In step S1005 (see FIG. 10), the central processing unit 303 subtracts data load of the stop-scheduled application from the data load. When the application C (App.C) is stopped, the data transfer rates in the paths 1210 shown in FIG. 12 become zero. As a result of the bottleneck analysis in the step S202, the predicted I/O rate 1711 as a result of collection with respect to the HBA port 113c is 300 MB/s which is not higher than the upper limit I/O rate 400 MB/s. In addition, the predicted I/O rate with respect to any other resource is not higher than the upper limit I/O rate. Accordingly, no bottleneck occurs.

FIG. 18 is an explanatory view showing the bottleneck analysis course at the stopped application C and shifting to the host C. An upper limit I/O rate 1802 and a predicted I/O rate 1803 in data transfer load in accordance with each resource 1801 are stored in the bottleneck analysis course 1800. When the application C (App.C) is stopped, the data transfer rates in the paths 1510 shown in FIG. 15 become zero. As a result of the bottleneck analysis in the step S202, the predicted I/O rates 1811 and 1812 as results of collection with respect to the CHA ports 131c and 131d are both 490 MB/s which is not higher than the upper limit I/O rate 500 MB/s. In addition, the predicted I/O rate with respect to any other resource is not higher than the upper limit I/O rate. Accordingly, no bottleneck occurs.

FIG. 19 is an explanatory view showing an example of the application shift information log. Information concerned with shifting of an application may be displayed as an operating history on the display unit 301 of the management server 100. The displayed information is a shifted application, a source transaction server, a destination transaction server and applications stopped on the basis of priority. Prediction of occurrence of a bottleneck is displayed as more detailed information. FIG. 19 shows shift information in the case where the application A is shifted from the host A to another host. Specifically, the possibility that a bottleneck may occur at shifting to the host B and the possibility that a bottleneck may occur at shifting to the host C are displayed. Therefore, the fact that the application C is stopped and the host B is decided as a destination host on the basis of priority definition (e.g. application priority table 324) is displayed.

In this embodiment, upon reception of an application fault notification from a host with a fault, the management server 100 for managing hosts performs data load conversion for converting data transfer load of the application on the SAN into data transfer load on destination host candidates to which the application with the fault will be shifted, and the management server 100 performs bottleneck analysis of communication paths on the basis of data transfer load after data load conversion. When bottlenecks occur in all destination host candidates as a result of the bottleneck analysis, the management server 100 acquires stoppable applications with lower priority than the application with the fault from the application priority table and decides stop-scheduled applications. The management server 100 performs the data load conversion and the bottleneck analysis on destination host candidates to which the application with the fault will be shifted in a condition that each stop-scheduled application is stopped. When no bottleneck occurs in all destination host candidates as a result of the bottleneck analysis, the management server 100 makes an instruction to stop the stop-scheduled applications, decides a destination host from the host candidates and instructs the host with the fault to shift the application. As a result, when an application currently operated on one host needs to be shifted to another host, the host to which the application should be shifted can be decided so that the influence of data transfer load is eliminated as extremely as possible.

### Embodiment 2

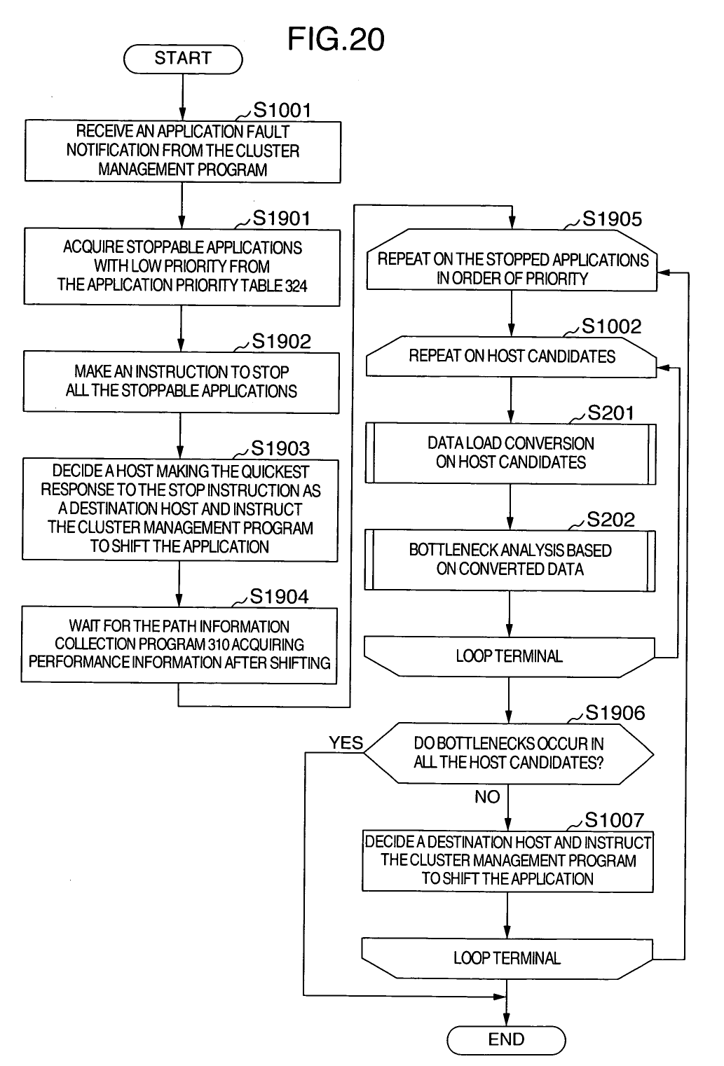

FIG. 20 is a flow chart showing steps of the destination host decision process in Embodiment 2. This embodiment is equal to Embodiment 1 in system configuration but different from Embodiment 1 in processing steps in the destination host decision program 311. First, an application with lower priority than the source application with respect to which a fault notification is received is stopped, and shifting of the source application is completed. Then, the stopped low-priority application is shifted in accordance with Embodiment 1. As a result, the time required for shifting the high-priority source application can be shortened while the influence of data transfer load on the source application can be reduced.

The central processing unit (CPU) 303 executes processing on the basis of the destination host decision program 311. Respective control portions of the hosts A, B and C execute processing on the basis of the cluster management programs 111a to 111c. The operations in respective steps will be described in connection with a specific example.

Step S1001 is the same as the step S1001 in FIG. 10. The central processing unit 303 acquires information of all stoppable applications with lower priority than the source application from the application priority table 324. In this specific example, the application B (App.B), the application C (App.C) and the application D (App.D) are acquired as the stoppable applications with lower priority than the application A (App.A) (step S1901). The central processing unit 303 gives a stop instruction to all the acquired stoppable applications. That is, the central processing unit 303 sends a stoppable application stop request to hosts on which the applications are operating. In this specific example, the hosts A, B and C are notified (step S1902). The central processing unit 303 decides a host making the quickest response to the stop instruction notified in the step S1902 as a destination host. This is because the operating state can be checked so that the time required for shifting the application can be shortened. The central processing unit 303 notifies the control portion of the decided host and shifts the application. As a specific example, assume that the control portion of the host C sends the quickest response to the central processing unit 303. The central processing unit 303 notifies the control portion of the host C and shifts the application A (App.A) (step S1903). The central processing unit 303 waits for the path information collection program 310 acquiring data transfer load after shifting of the application A (App.A). This is because change in data transfer load due to shifting of the application A (App.A) is reflected (step S1904). The central processing unit 303 repeats the following steps on all the applications stopped in the step S1902 in order of priority. In this specific example, the applications D (App.D), the application B (App.B) and the application C (App.C) are processed in this order (step S1905).

Steps S1002, S201 and S202 are the same as those in Embodiment 1. The central processing unit 303 performs the data load conversion step S201 and the bottleneck analyzing step S202 on the stopped applications. The central processing unit 303 terminates processing when bottlenecks occur in all host candidates as a result of the bottleneck analysis. This is because all the stoppable hosts have been already stopped so that there is no possibility that the bottleneck will be improved any more (step S1906).

Step S1007 is the same as in Embodiment 1. The central processing unit 303 decides a destination host from host candidates free from any bottleneck and notifies the control portion of the destination host. When there are hosts satisfying the condition, for example, a host least in deviation of data loads on the respective resources is selected as a destination host.

In this embodiment, the management server 100 for managing hosts executes: a stoppable application decision step (step S1901) for selecting stoppable applications with lower priority than the source application selected in the source host when the application needs to be shifted; a step (step S1902) for giving a stop instruction to hosts on which the decided stoppable applications are operating; and an application shift step (step S1903) for deciding a host making the quickest response to the stop instruction as a destination host, instructing the decided destination host to start the same application as the source application and instructing the source host to shift the selected application. Accordingly, when an application currently operated on one host needs to be shifted to another host, a host to which the application should be shifted can be decided so that the influence of data transfer load is eliminated as extremely as possible.

In the aforementioned embodiments, CHA ports 131a to 131d and HBA ports 113a to 113e are used as resources on the SAN. The resources, however, need not be limited to the CHA ports 131a to 131d and the HBA ports 113a to 113e. For example, fibre channel switches for constructing a FC network 140 may be used as resources. In this case, when fibre channel switches are collectively stored in the path load table 320 in FIG. 4, data transfer loads can be collected in accordance with each fibre channel switch by the bottleneck analysis process S202 so that bottlenecks with respect to the FC network 140 other than the bottlenecks with respect to the ports can be evaluated.

Although the embodiments have been described on the case where the turning point of shifting an application is when a fault is detected in the application, when a fault is detected in logical paths passing through the HBAs and CHAs or when the user designates shifting of the application for initial evaluation, the turning point need not be limited thereto. For example, the turning point of shifting an application may be set when a server manager judges that application service cannot be provided in a response time satisfactory to users because the users are concentrated in a specific host though there is neither fault in application nor fault in path.

The present invention can be applied to the purpose of deciding a host to which an application should be shifted so that the influence of data transfer load is eliminated as extremely as possible. For example, the invention can be applied to the purposes of a SAN management method and a SAN management system in which an application is shifted by a cluster system.

1. A SAN management method for deciding a destination host in a system in which a plurality of hosts each executing an application can be made to communicate with a storage through a storage area network (SAN) and with a management server through a local area network (LAN) so that, when a fault occurs in an application in any one of the hosts, the application with the fault is shifted to another host, wherein:
upon reception of an application fault notification from a host with a fault,
the management server performs data load conversion for converting data transfer load of the application with the fault on the SAN into data transfer load on destination host candidates to which the application with the fault will be shifted, and performs bottleneck analysis of communication paths on the basis of the data transfer load obtained by the data transfer load conversion;
when bottlenecks occur in all the destination host candidates as a result of the bottleneck analysis, the management server acquires stoppable applications with lower priority than the application with the fault from an application priority table, decides stop-scheduled applications and performs the data load conversion and the bottleneck analysis on the destination host candidates to which the application with the fault will be shifted in a condition that the stop-scheduled applications are stopped; and
when no bottleneck occurs in all the destination host candidates as a result of the bottleneck analysis, the management server makes an instruction to stop the stop-scheduled applications, decides a destination host from the host candidates and instructs the host with the fault to shift the application.

2. A SAN management method for collecting and analyzing data transfer load on communication paths in a system in which a plurality of hosts and a storage are connected to a storage area network (SAN), wherein a management server for managing the hosts executes:
a data load conversion step of converting data transfer load on the SAN with respect to a selected source application on a source host into data transfer load of the source application on destination host candidates to which the selected application will be shifted;
a bottleneck analyzing step of performing bottleneck analysis of communication paths on the basis of the data transfer load obtained by the data load conversion; and
a destination host decision step of executing the data load conversion step and the bottleneck analyzing step on the destination host candidates and deciding a destination host from the non-bottlenecked host candidates.

3. A SAN management method according to claim 2, wherein the data load conversion step includes the steps of:
specifying volumes corresponding to the source application;
collecting data transfer loads corresponding to the specified volumes in accordance with each volume; and
allocating the collected data transfer load to communication paths of the destination host equally.

4. A SAN management method according to claim 3, wherein the step of collecting the data transfer loads in accordance with each volume includes the step of multiplying the value of the collected data transfer load by a volume-use ratio in accordance with each application.

5. A SAN management method according to claim 3, wherein the step of collecting the data transfer loads in accordance with each volume includes the step of multiplying the value of the collected data transfer load by a conversion rate based on performance difference between the hosts.

6. A SAN management method according to claim 2, wherein the bottleneck analyzing step includes the steps of:
collecting the converted data transfer loads in accordance with each resource on the SAN; and
comparing the value of the collected data transfer load with an upper limit of performance of each resource.

7. A SAN management method according to claim 6, wherein the resources contain at least one of a communication path port and a fibre channel switch.

8. A SAN management method according to claim 2, wherein the destination host decision step includes the step of deciding applications to be stopped when bottlenecks occur in all the destination host candidates.

9. A SAN management method according to claim 8, wherein the step of deciding applications to be stopped selects stoppable applications with lower priority than the source application.

10. A SAN management method according to claim 2, wherein the destination host decision step includes the step of making an instruction to start the same application as the source application selected on the host decided as a destination host and instructs the source host to shift the application.

11. A SAN management method for collecting and analyzing data transfer loads on communication paths in a system in which a plurality of hosts and a storage are connected to a storage area network (SAN), wherein a management server for managing the hosts executes:
a stoppable application decision step of selecting stoppable applications with lower priority than a source application selected on a source host for shifting the application;
a stop instruction step of instructing the decided stoppable application-operating hosts to stop the stoppable applications; and
an application shift step of deciding a host making the quickest response to the stop instruction as a destination host, instructing the decided destination host to start the same application as the source application and instructs the source host to shift the selected application.

12. A SAN management system for collecting and analyzing data transfer loads on communication paths in a system in which a plurality of hosts and a storage are connected to a storage area network (SAN), the SAN management system comprising:
data load conversion means for converting data transfer load on the SAN with respect to a selected source application on a source host into data transfer load of the source application on destination host candidates to which the application will be shifted;
bottleneck analyzing means for performing bottleneck analysis of communication paths on the basis of the data transfer load obtained by the data load conversion; and
destination host decision means for executing the data load conversion means and the bottleneck analyzing means on the destination host candidates and deciding a destination host from the non-bottlenecked host candidates.

13. A SAN management system according to claim 12, wherein the data load conversion means specifies volumes corresponding to the source application, collects data transfer loads corresponding to the specified volumes in accordance with each volume, and allocates the collected data transfer load to communication paths of the destination host equally.

14. A SAN management system according to claim 13, wherein the data load conversion means multiplies the value of the collected data transfer load by a volume-use ratio of each application in accordance with each volume.

15. A SAN management system according to claim 13, wherein the data load conversion means multiplies the value of the collected data transfer load by a conversion rate based on performance difference between the hosts in accordance with each volume.

16. A SAN management system according to claim 12, wherein the bottleneck analyzing means collects the converted data transfer loads in accordance with each resource on the SAN, and compares the value of the collected data transfer load with an upper limit of performance of each resource.

17. A SAN management system according to claim 12, wherein the destination host decision means decides applications to be stopped when bottlenecks occur in all the destination host candidates.

18. A SAN management system according to claim 17, wherein the destination host decision means selects stoppable applications with lower priority than the source application when the applications to be stopped are decided.

19. A SAN management system according to claim 12, wherein the destination host decision means makes an instruction to start the same application as the source application selected on the host decided as a destination host and instructs the source host to shift the application.

20. A SAN management system for collecting and analyzing data transfer loads on communication paths in a system in which a plurality of hosts and a storage are connected to a storage area network (SAN), the SAN management system comprising:
stoppable application decision means for selecting stoppable applications with lower priority than a source application selected on a source host for shifting the application;
stop instruction means for instructing the decided stoppable application-operating hosts to stop the stoppable applications; and
application shift means for deciding a host making the quickest response to the stop instruction as a destination host, instructing the decided destination host to start the same application as the source application and instructs the source host to shift the selected application.
